(19) United States
(12) Patent Application Publication
(10) Pub. No.: US 2007/0173600 A1
(43) Pub. Date: Jul. 26, 2007

(54) Multi-constituent system containing at least three constituents, method for the production thereof, and use of the same

(75) Inventors: Nicole Eggers, Emsdetten (DE); Christoph Schmidt, Munster (DE); Andreas Vogt, Munster (DE); Gisela Laumann, Munster (DE)

Correspondence Address: BASF CORPORATION;Patent Department, 1609 BIDDLE AVENUE, MAIN BUILDING, WYANDOTTE, MI, 48192, US

(73) Assignee: BASF COATINGS AG, 48165 MÜNSTER (DE)

(21) Appl. No.: 10/599,681

(22) PCT Filed: Mar. 31, 2005
(86) PCT No.: PCT/EP05/51530

§ 371 Date: Oct. 5, 2006

(30) Foreign Application Priority Data
Apr. 14, 2004 (DE) 102004018014.8

(51) Int. Cl. C08G 18/08

(52) U.S. Cl. 524/589

(57) ABSTRACT

A multicomponent system comprising at least three components, comprising (I) a component which is free from chlorinated polyolefins and is curable with polyisocyanates, comprising (I.1) at least one binder containing isocyanate-reactive functional groups and (1.2) at least one organic solvent, (II) a component free from binders (I.1), comprising (II.1) at least one chlorinated polyolefin and (II.2) at least one organic solvent, (III) a component consisting of or comprising at least one polyisocyanate (III.1); processes for its preparation, and its use.

The present invention relates to a new multicomponent system comprising at least three components. The present invention also relates to a process for preparing a new multicomponent system comprising at least three components. The present invention additionally relates to the use of the new multicomponent system comprising at least three components for producing adhesion-promoting and energy-absorbing coatings.

Multicomponent systems which comprise
a polyisocyanate-curable component comprising at least one binder containing isocyanate-reactive functional groups, at least one chlorinated polyolefin and at least one organic solvent,
a component comprising at least one polyisocyanate and
a component comprising at least one organic solvent
   are known for example from European patent application EP 0 982 353 A1. The known multicomponent systems, though, have the disadvantage that predominantly they can be used only as adhesion promoters or primers on plastics parts composed of TPO, i.e., a blend of maleinized polypropylene, an elastomer and an amine-terminated polyether. Additionally the storage stability of the polyisocyanate-curable component leaves something to be desired. Thus after two to three months of storage it is prone to severe phase separation and to sedimentation of the chlorinated polyolefin together with the additives present, such as adjuvants, pigments and fillers. In order to be at all useful the polyisocyanate-curable component must be homogenized again by intensive stirring, which occasions additional costs in the paintshop. After six to eight months of storage there is irreversible formation of inhomogeneities, rendering the polyisocyanate-curable component completely unusable.

It was therefore an object of the present invention to provide a new multicomponent system, comprising at least three components, which no longer has the disadvantages of the prior art but instead whose polyisocyanate-curable component is stable on storage and after a storage period of more than three months shows no phase separation and no sedimentation of its constituents and which also shows no irreversible formation of inhomogeneities even after a storage period of more than eight months. The new multicomponent system, comprising at least three components, ought additionally to be easy to prepare and easy to process to coating materials. The coating materials in question ought to be highly suitable for producing adhesion-promoting and/or energy-absorbing primer and/or surfacer coatings on a very wide variety of plastics and coating material surfaces, so that they can be used with advantage in automotive OEM finishing and in automotive refinish. The coatings in question ought to display particularly good adhesion to the substrates and to coats applied over them, even following moisture exposure.

The invention accordingly provides the new multicomponent system, comprising at least three components, which comprises
(I) a component which is free from chlorinated polyolefins and is curable with polyisocyanates, comprising
   (I.1) at least one binder containing isocyanate-reactive functional groups and
   (1.2) at least one organic solvent,
(II) a component free from binders (I.1), comprising
   (II.1) at least one chlorinated polyolefin and
   (II.2) at least one organic solvent,
(III) a component consisting of or comprising at least one polyisocyanate (III.1);
   and is referred to below as “multicomponent system of the invention”.

The invention also provides the new process for preparing the multicomponent system of the invention, which involves preparing components (I), (II) and (III) and, where used, (IV) separately from one another by mixing their respective constituents and homogenizing the resulting mixtures, and which is referred to below as “process of the invention”.

The invention further provides for the use of the multicomponent system of the invention for preparing coating materials, which is referred to below as “inventive use”.

In the light of the prior art it was surprising and unforeseeable for the skilled worker that the object on which the present invention was based could be achieved by means of the multicomponent system of the invention, of the process of the invention and of the inventive use.

In particular it was surprising that the multicomponent system of the invention no longer had the disadvantages of the prior art but instead its polyisocyanate-curable component (I) was completely stable on storage and even after a storage period of more than three months no longer displayed any phase separation or sedimentation of its constituents and also no longer displayed any irreversible formation of inhomogeneities after a storage period of more than eight months.

In addition it was possible to prepare the multicomponent system of the invention by means of the process of the invention in a particularly simple way and with very high reproducibility.

Furthermore, the multicomponent system of the invention could be processed very effectively to coating materials, in the context of the inventive use.

The coating materials in question were highly suitable for producing adhesion-promoting and/or energy-absorbing primer and/or surfacer coatings on a very wide variety of plastics and coating material surfaces, and so could be used with advantage in automotive OEM finishing and automotive refinish.

The primer and surfacer coatings in question displayed particularly good adhesion to the substrates and to coats applied over them, even after moisture exposure. The surfacer coatings additionally afforded outstanding protection against damage from mechanical exposure, such as stone chipping.

The multicomponent system of the invention comprises at least three, in particular three, components (I), (II) and (III).

Component (I) is free from chlorinated polyolefins and can be cured with polyisocyanates.

It comprises at least one oligomeric or polymeric binder (I.1) containing at least two, preferably at least three and in particular at least four isocyanate-reactive functional groups in solution and/or dispersion in at least one organic solvent (I.2).

Examples of suitable binders (I.1) for use in component (I) are known from German patent applications
DE 42 04 518 A 1, page 3 line 55 to page 5 line 9;
DE 44 21 823 A 1, page 4 line 4 to page 11 line 17;
DE 198 55 125 A 1, page 3 line 14 to page 4 line 1, and page 4 line 2 to page 11 line 39;
DE 198 55 167 A 1, page 3 para. [0032] to page 12 para. [0121];
DE 199 04 317 A 1, page 3 line 6 to page 12 line 19; or
DE 199 14 899 A 1, page 3 line 15 to page 8 line 32, and page 8 line 32 to page 17 line 6,
DE 199 24 171 A 1, page 5 line 54 to page 7 line 34;
   from international patent applications
WO 97/14731 A 1, page 10 line 30 to page 36 line 5; or
WO 98/38230 A 1, page 10 line 15 to page 13 line 20; or
   from the American patent
U.S. Pat. No. 5,466,745 A 1, column 5 line 43 to column 7 line 6.

Preferably component (I) contains the binder (I.1) in an amount of from 5 to 50%, more preferably from 10 to 40% and in particular from 15 to 30% by weight, based in each case on the solids of component (I).

Suitable solvents are all organic solvents (I.2) which under the conditions of the preparation, storage and further processing of component (I) do not react with the binders (I.1). Toward the polyisocyanates (III.1) of component (III) described below the organic solvents may be inert or reactive, i.e. may contain isocyanate-reactive functional groups. They may also be reactive in the sense of participating in curing with actinic radiation. Where they are reactive they are referred to as reactive diluents. Preferably the organic solvents (I.2) are inert.

By actinic radiation is meant electromagnetic radiation, such as near infrared (NIR), visible light, UV radiation, X-rays or gamma radiation, especially UV radiation, and corpuscular radiation, such as electron beams, beta radiation, neutron beams and proton beams, especially electron beams.

Examples of suitable organic solvents are known from the book “Paints Coatings and Solvents”, Dieter Stoye and Werner Freitag (editors), Wiley-VCH, Weinheim, N.Y., 2nd edition, “14. Solvents”, pages 277 to 373, and from German patent applications DE 199 14 899 A 1, page 17 lines 23 to 33 in conjunction with page 11 line 47 to page 12 line 8, or DE 101 29 970 A 1 page 11 para. [0102] with reference to German patent application DE 198 18 735 A 1, column 7 lines 1 to 25. Preference is given to using esters and aromatics.

Examples of suitable isocyanate-reactive functional groups are hydroxyl groups, thiol groups and primary and secondary amino groups, particularly hydroxyl groups.

Component (I) may otherwise include customary and known additives (I.3) in effective amounts, such as physically curable binders other than the above-described binders (I.1); pigments and fillers; molecularly dispersely soluble dyes; light stabilizers, such as UV absorbers and reversible free-radical scavengers (HALS); antioxidants; wetting agents; emulsifiers; slip additives; polymerization inhibitors; thermal crosslinking catalysts; thermolabile free-radical initiators; photoinitiators and photo-coinitiators; adhesion promoters; leveling agents; film-forming auxiliaries; rheological aids or rheological control additives (thickeners and pseudoplastic sag control agents, SCA); flame retardants; corrosion inhibitors; waxes, siccatives; biocides and/or dulling agents. Further examples of suitable additives are described in German patent applications
DE 44 21 823 A 1, page 11 lines 18 to 30, and page 11 page 35 to page 12 line 3;
DE 199 14 899 A 1, page 17 lines 35 to 43, page 17 line 39 to page 18 line 37 and page 19 lines 10 to 66;
DE 101 29 970 A 1, page 11 para. [0106] to page 12 para. [0121], and also page 12 para. [0123]; or in
the textbook “Lackadditive” [Additives for coatings] by Johan Bieleman, Wiley-VCH, Weinheim, N.Y., 1998.

Component (II) is free from binders (I.1). Preferably it is also free from additives (I.3). It comprises at least one chlorinated polyolefin (II.1) and at least one organic solvent (II.2), preferably at least two and in particular two organic solvents (II.2). With preference it consists of these constituents.

The chlorinated polyolefin (II.1), based in each case on its total amount, contains preferably from 10 to 45%, more preferably from 10 to 25% and in particular from 15 to 20% by weight of chlorine and has a number-average molecular weight of from 7000 to 200 000 and preferably from 8000 to 50 000 daltons. Examples of suitable chlorinated polyolefins are described for example in German patent DE 196 46 610 C1, column 3 lines 2 to 34. Preferably component (II), based in each case on its total amount, contains from 5 to 40% and more preferably from 10 to 35% by weight of the chlorinated polyolefin (II.1).

Examples of suitable organic solvents (II.2) are the above-described organic solvents (I.2).

Surprisingly component (II) is extremely stable on storage and can be used as it is directly for producing adhesion-promoting primer coatings with a film thickness of up to 15 μm, in particular 10 μm, on plastics, which is an additional key advantage.

The multicomponent system of the invention further comprises a component (III) which comprises at least one polyisocyanate (III.1). Preferably component (III) is liquid. Preferably component (III) therefore comprises at least one inert organic solvent (III.2). Particular preference is given to using for this purpose the above-described inert organic solvents (I.2).

The polyisocyanates (III.1) may also contain reactive functional groups which can be activated with actinic radiation and so are able to participate in curing with actinic radiation. Such polyisocyanates (III.1) are referred to below as “Dual-cure polyisocyanates (III.1)”.

Examples of suitable polyisocyanates (III.1) for use in components (III) are known from German patent applications
DE 44 21 823 A 1, page 12 lines 4 to 35; or
DE 199 14 899 A 1, page 18 line 40 to page 19 line 9 and page 19 line 67 to page 20 line 12.

Examples of suitable dual-cure polyisocyanates (III.1) for use in component (III) are known from German patent application DE 101 29 970 A 1, page 2 para. [0008] with reference to European patent application EP 0 928 800, and also page 6 para. [0042] to page 11 para. [0099].

Component (III) may further comprise at least one additive (I.3) which is inert toward isocyanates under preparation and processing conditions but is catalytically active in respect of crosslinking or curing, such as dibutyltin dilaurate.

The multicomponent system of the invention may further comprise at least one component (IV), which preferably may comprise or consist of the above-described organic solvents (I.2) and/or the above-described additives (I.3).

Components (I), (II) and (III) and, where used, (IV) are anhydrous. That is, they contain no water or only traces of water introduced unintentionally during the preparation and/or handling of the components.

The multicomponent system of the invention is preferably prepared by means of the process of the invention. For that purpose components (I), (II) and (III) and, where used, (IV) are prepared separately from one another by mixing of their respective constituents in the desired amounts and homogenization of the resulting mixtures. This can be done using conventional mixing methods and apparatus such as stirred tanks, mills with agitator mechanisms, extruders, kneading apparatus, Ultraturrax, inline dissolvers, static mixers, toothed-wheel dispersers, pressure release nozzles and/or microfluidizers. Preparation takes place where appropriate in the absence of actinic radiation, where the resultant components (I) to (III) and, where used, (IV), include constituents which can be activated by actinic radiation.

Up until the time of their inventive use components (I), (II) and (III) and, where used, (IV) of the multicomponent system of the invention are stored separately from one another. In the course of such storage the components, particularly components (I) and (II), prove extremely stable, so that even after a storage period of more than nine months there is no longer any phase separation nor any irreversible formation of inhomogeneities.

The multicomponent system of the invention is versatile, being useful for example for preparing adhesives and sealants which serve for producing adhesive layers and seals. In particular it is used in accordance with the invention for preparing coating materials.

For preparing coating materials components (I), (II) and (III) and, where used, (IV) are mixed with one another in the desired amounts and then the resulting mixtures are homogenized. This can be done using the above-described apparatus and methods.

Preferably components (I), (II) and (III) and, where used, (IV) are mixed with one another in a proportion such that in the resulting coating materials the equivalent ratio of isocyanate-reactive functional groups to isocyanate groups is from 1:2 to 2:1, more preferably from 1:1.5 to 1.5:1 and in particular from 1:1.2 to 1.2:1.

With preference components (I), (II) and (III) and, where used, (IV) are mixed with one another in a proportion such that the resultant coating materials, based in each case on their solids, contain from 0.5 to 15%, more preferably from 1 to 12% and in particular from 1.5 to 10% by weight of at least one chlorinated polyolefin (II.1).

The resulting coating materials are thermally curable. This means that they can be cured at room temperature or at higher temperatures. This can be done using the conventional apparatus, such as forced-air ovens, hot-air blowers or radiant heaters, especially NIR or IR rays or microwave emitters.

The resulting coating materials may also be curable thermally and with actinic radiation, this being referred to by those in the art as dual cure. Cure can be effected using the conventional apparatus, such as UV lamps or electron beam sources (cf. also German patent application DE 101 29 970 A 1, page 13 para. [0132]).

Preferably the coating materials are thermally curable.

The coating materials can be prepared easily and with great reproducibility. They have a processing time or pot life which is more than sufficient for their reliable and convenient further processing in the paintshop.

The coating materials are used with preference for producing adhesion-promoting and/or energy-absorbing coatings, especially primer coatings, preferably with a film thickness of from 10 to 25 μm, more preferably from 15 to 20 μm, and/or surfacer coatings, preferably with a film thickness of from 25 to 45 μm, more preferably from 30 to 40 μm, on a wide variety of substrates.

The substrates may be planar or three-dimensional in shape. They may be composed of metals. They may also carry surface coatings of thermoplastics or thermoset materials, such as coating materials, or may be composed of such thermoplastics or thermoset materials. Suitable plastics include for example ABS, AMMA, ASA, CA, CAB, EP, UF, CF, MF, MPF, PF, PAN, PA, PE, HDPE, LDPE, LLDPE, UHMWPE, PC, PC/PBT, PC/PA, PET, PMMA, PP, PS, SB, PUR, PVC, RF, SAN, PBT, PPE, POM, PUR-RIM, SMC, BMC, PP-EPDM and UP (abbreviations to DIN 7728T1). In this context it is not necessary to roughen the plastics by flame or corona or plasma pretreatment; rather it is sufficient to preclean the plastic with a suitable solvent, to abrade it with fine abrasive paper or with an abrasive pad and to give it a final clean with the solvent. This constitutes a very particular advantage of the multicomponent system of the invention, of the coating materials prepared therefrom and of their inventive use.

The coating materials, adhesives and sealants can therefore be used in particular for coating, adhesively bonding and sealing bodies of means of transport, including means of transport driven by engine power and/or muscle power, such as automobiles, commercial vehicles, buses, cycles, rail vehicles, watercraft and aircraft, and parts thereof, constructions and parts thereof, doors, windows, furniture, small industrial parts, mechanical, optical and electronic components, coils, containers, packaging, hollow glassware and articles of everyday use.

Application of the coating materials, adhesives and sealants, in particular of the coating materials, to the aforementioned substrates may take place by any usual application methods, such as spraying, knifecoating, brushing, pouring, dipping, impregnating, trickling or rolling, for example. At application the substrate to be coated may itself be at rest, with the application equipment or unit being moved. Alternatively the substrate for coating, in particular a coil, may be moving, with the application unit at rest relative to the substrate or being moved appropriately.

The coating materials prove to be particularly easy and reliable to apply. Before being cured, the resulting wet films can be overcoated wet on wet and subsequently cured together with the films applied over them (wet-on-wet technique).

The coating materials, adhesives and sealants, particularly the coating materials, can alternatively be cured immediately following their application, by means of the above-described apparatus and methods.

The resulting adhesive layers produce a durable, firmly adhering bond between the substrates to be bonded, which is not parted even by exposure to moisture, light and/or sharply fluctuating temperatures.

The resulting seals are stable to mechanical, chemical and thermal exposure and therefore seal the substrates durably.

The resulting coatings, particularly the primer coatings and surfacer coatings, can likewise be overcoated very effectively.

Even after moisture exposure the coatings exhibit particularly good adhesion to the substrates and to the coats applied over them. In particular the surfacer coatings afford outstanding protection against damage from mechanical exposure, such as stone chipping. The quality of the coatings is so outstanding that they can be used for automotive OEM finishing and automotive refinish.

### EXAMPLES

### Examples 1 and 2

The Preparation of Multicomponent Systems 1 and 2

1. The Preparation of Components (I):

1.1 The Preparation of Component (Ia):

To prepare component (Ia) first of all 25.9 parts by weight (calculated as solid) of a hydroxyl-containing methacrylate copolymer (Macrynal® SM 515 from Hoechst) and 0.46 part by weight of Disperbyk® 110 (dispersing assistant from Byk Chemie) and 0.28 part by weight of Byk® P104S (surface-active additive from Byk Chemie) were mixed with one another and then the resulting mixture was homogenized.

Into the homogenized mixture there were incorporated homogeneously by stirring, in a dissolver, 0.93 part by weight of Bentone® 34 from Rheox (organically modified smectites and bentonites) and 0.46 part by weight of Aerosil® R972 from Degussa (pyrogenic silica), the dissolver being operated until the rheological aids had been incorporated.

Thereafter 0.37 part by weight of Nero Flammruss 101 from Degussa (lamp black), 13 parts by weight of titanium dioxide Tiona® RCL-472 from Millennium, 6.5 parts by weight of aluminum silicate ASP 600 from Langer, 7.4 parts by weight of zinc phosphate ZP-BS-M from Waardals and 13% by weight of Halox® SZP-391 from Heubach (calcium/strontium/zinc/phosphorus silicates) were incorporated with stirring, and then the resulting mixture was ground to a grade of 15 to 18 μm on a mill with agitator mechanism (ZWM from Naintzsch).

Subsequently 22.5 parts by weight of esters and 2 parts by weight of aromatics were added, and then component (Ia) was made up by addition of 1.9 parts by weight of Baysilon® OL 44 (leveling agent from Borchers), 0.5 part by weight (calculated as resin solids) of an organic solution of nitrocellulose chips E 510 from Wolff Walsrode and 0.1 part by weight of a 10 per cent strength organic solution of dibutyltin dilaurate.

The resulting component (Ia) was extremely stable on storage and even after 9 months of storage showed no phase separation and no formation of inhomogeneities.

1.2 The Preparation of Component (Ib):

To prepare component (Ib) first of all 25.41 parts by weight (calculated as solid) of a hydroxyl-containing methacrylate copolymer (Macrynal® SM 515 from Hoechst) and 0.28 part by weight of Disperbyk® 111 (dispersing assistant from Byk Chemie) and 0.23 part by weight of Byk® P104S (surface-active additive from Byk Chemie) were mixed with one another and then the resulting mixture was homogenized.

Into the homogenized mixture there were incorporated homogeneously by stirring, in a dissolver,b 0.9 part by weight of Bentone® 34 from Rheox (organically modified smectites and bentonites) and 0.46 part by weight of Aerosil® R972 from Degussa (pyrogenic silica), the dissolver being operated until the rheological aids had been incorporated.

Thereafter 0.037 part by weight of Bayferrox® 316 from Bayer AG, 12.9 parts by weight of titanium dioxide Tiona® RCL-472 from Millennium, 6.5 parts by weight of aluminum silicate ASP 600 from Langer, 4.6 parts by weight of Luzenac® from Talc de Luzenac (magnesium aluminum silicate), 7.4 parts by weight of Heucophos® ZPA from Heubach (zinc phosphate) and 5.5 parts by weight of Heucophos® CAPP from Heubach (calcium aluminum polyphosphate silicate hydrate) were incorporated with stirring, and then the resulting mixture was ground to a grade of 15 to 18 μm on a mill with agitator mechanism (ZWM from Naintzsch).

Subsequently 25 parts by weight of esters and 2 parts by weight of aromatics were added, and then component (Ib) was made up by addition of 1.9 parts by weight of Baysilon® OL 44 (leveling agent from Borchers), 0.53 part by weight (calculated as resin solids) of an organic solution of nitrocellulose chips E 510 from Wolff Walsrode and 0.1 part by weight of a 10 per cent strength organic solution of dibutyltin dilaurate.

The resulting component (Ib) was extremely stable on storage and even after 9 months of storage showed no phase separation and no formation of inhomogeneities.

2. The Preparation of Components (II):

2.1 The Preparation of Component (IIa):

Component (IIa) was prepared by mixing 62 parts by weight of esters, 18 parts by weight of aromatics and 20 parts by weight of the chlorinated polyolefin CP 343.3 from Eastman and homogenizing the resulting mixture.

2.2 The Preparation of Component (IIb):

Component (IIb) was prepared by mixing 54.5 parts by weight of esters, 10.5 parts by weight of aromatics and 35 parts by weight of the chlorinated polyolefin CP 343.3 from Eastman and homogenizing the resulting mixture.

Components (IIa) and (IIb) were stable on storage and even after a storage period of more than eight months showed no phase separation nor any formation of inhomogeneities. Surprisingly they could also be used directly for producing adhesion-promoting primer coatings with a film thickness of up to 15 μm on plastics.

3. The Preparation of Component (III):

Component (III) was prepared from 30 parts by weight of Basonat® HI 190/B/S from BASF Aktiengesellschaft (isocyanurate based on hexamethylene diisocyanate), 8.4 parts by weight of an isocyanurate based on isophorone diisocyanate, 61.2 parts by weight of organic solvents (mixture of esters and aromatics) and 0.4 part by weight of a 10 per cent strength solution of dibutyltin dilaurate in an organic solvent.

4. Multicomponent System 1:

The multicomponent system 1 of Example 1 consisted of components (Ia), (IIa) and (III).

5. Multicomponent System 2:

The multicomponent system 2 of Example 2 consisted of components (Ib), (IIb) and (II).

Multicomponent systems 1 and 2 were outstandingly suitable for preparing coating materials.

### Examples 3 and 4

The Production of Coatings Using the Multicomponent Systems 1 and 2

For Example 3 the multicomponent system 1 of Example 1 was used.

For Example 4 the multicomponent system 2 of Example 2 was used.

The coating material 1 of Example 3 was prepared using multicomponent system 1 by mixing components (Ia), (IIa) and (III) with one another in a weight ratio of 2:1:1 and homogenizing the resulting mixture.

The coating material 2 of Example 4 was prepared using multicomponent system 2 by mixing components (Ib), (IIb) and (III) with one another in a weight ratio of 2:1:1 and homogenizing the resulting mixture.

The components of the multicomponent systems 1 and 2 were mixable with one another without problems within a short time. The resulting coating materials 1 and 2 had a volatile organic compounds (VOC) content which met the art requirements of VOC<540 g/l or 4.5 lb/gal. Coating materials 1 and 2 had a processing time or pot life of several hours and were therefore convenient to process. In particular they could be applied very easily by means of conventional spray application techniques.

Coating materials 1 and 2 were applied using spraygun SATA® No. 2000-1.3 mm with a spraying pressure of 2 bar to plastics substrates in a wet film thickness which resulted, after drying and curing of the wet films 1 and 2, in surfacer coatings 1 and 2 having dry film thicknesses of 30 μm.

The plastics substrates consisted of polypropylene impact-modified with EPDM rubber, of polycarbonate and of white- and black-colored TPO (blend of maleinized polypropylene, an elastomer and an amine-terminated polyether) whose surface had merely been precleaned with a suitable solvent, abraded with fine abrasive paper and given a final clean with the solvent.

In a first series the plastics substrates coated with the wet films 1 and 2 were overcoated wet on wet with a known two-component solid-color topcoat material from BASF Coatings AG. In a second series they were overcoated wet on wet with a known metallic basecoat material and with a known two-component clearcoat material (both from BASF Coatings AG). Subsequently the wet films were cured together (wet-on-wet technique). All of the resulting coatings were free from surface defects such as bits.

All of the coatings exhibited outstanding adhesion to all plastics substrates (cross-cut test to DIN EN ISO 2409: Gt 0; Mercedes-Benz LPV 2200.40100 with blade: satisfactory), and this adhesion did not decrease even following moisture exposure (spray water test BASF inventory number 1490, 240 h; spray water test and 240 h constant-climate test to DIN EN 50017) and after a post-exposure rest time of 1 h and 24 h and also at low temperatures (−40° C.). The outstanding overall visual appearance of the topcoats was also fully retained.

1. A multicomponent system comprising at least three components, comprising
(I) a component which is free from chlorinated polyolefins and is curable with polyisocyantes, comprising
(I.1) at least one binder containing isocyanate-reactive functional groups and
(1.2) at least one organic solvent
(II) a component free from binders (I.1), comprising
(II.1) at least one chlorinated polyolefin and
(II.2) at least one organic solvent,
(III) a component comprising at least one polyisocyante (III.1).

2. The multicomponent system as claimed in claim 1 wherein component (II) comprises, based on its total amount
(II.1) from 5 to 40% by weight of at least one chlorinated polyolefin, calculated as solids.

3. The multicomponent system as claimed in claim 2, wherein component (II) comprises, based on its total amount
(II.1) from 10 to 35% by weight of at least one chlorinated polyolefin.

4. The multicomponent system of claim 1, wherein the chlorinated polyolefin (II.1) comprises, based on its total amount, from 10 to 45% by weight of chlorine.

5. The multicomponent system of claim 4, wherein the chlorinated pololefin (II.1) comprises, based on its total amount, from 15 to 20% by weight of chlorine.

6. The multicomponent system of claim 1, to wherein component (I) comprises
(I.3) at least one additive.

7. The multicomponent system as claimed in claim 6, wherein the additive (1.3) is selected from the group consisting of physically curable binders other than the above-described binders (I.1); pigments; molecularly dispersely soluble dyes; light stabilizers; antioxidants; wetting agents; emulsifiers; slip additives; antisettling agents; polymerization inhibitors; thermal crosslinking catalysts; thermolabile free-radical initiators; photoinitiators; photo-coinitiators; adhesion promoters; leveling agents; film-forming auxiliaries; rheological aids; thickeners; pseudoplastic sag control agents; SCA; flame retardants; corrosion inhibitors; waxes, siccatives; biocides; dulling agents; and mixtures thereof.

8. The multicomponent system of claim 1, wherein organic solvents (I.2) and (II.2) comprise isocyante-reactive groups.

9. The multicomponent system of claim 1, wherein the isocyanate-reactive functional groups are selected from the group consisting of hydroxyl groups, thiol groups and primary and secondary amino groups.

10. The multicomponent system of claim 1, wherein component (III) comprises at least one inert organic solvent (III.2).

11. The multicomponent system of claim 1, further comprising at least one other component (IV).

12. A process for preparing the multicomponent system comprising as least three components of claim 1, comprising preparing components (I), (II) and (III) separately from one another by mixing their respective constituents and homogenizing the mixtures.

13. A method of coating a substrate comprising applying the multicomponent system of claim 1 to a substrate.

14. The method of claim 13, wherein the coating materials are prepared by mixing components (I), (II) and (III) and homogenizing the resulting mixtures.

15. The process of claim 2, wherein components (I), (II) and (III) are mixed with one another in a proportion such that in the resulting coating materials the equivalent ratio of isocyanate-reactive functional groups to isocyanate groups is from 1:2 to 2:1.

16. The process of claim 2, wherein the coating materials, based on their solids, contain from 0.5 to 15% by weight of at least one chlorinated polyolefin (II.1).

17. The method of claim 13, wherein the multicomponent system is is an adhesion-promoting and/or energy-absorbing coating.

18. The method of claim 3, wherein the substrates comprises a surface coating comprising a thermoplastic or thermoset material.

19. The method of claim 17 wherein the multicomponent comprises an adhesion-promoting primer coating having a film thickness of up to 15 um and the substrate comprises a plastic.

20. The method of claim 19 wherein the adhesion promoting primer coating has a film thickness of up to 10 um.
